(19) United States
(12) Patent Application Publication
(10) Pub. No.: US 2008/0059981 A1
(43) Pub. Date: Mar. 6, 2008

(54) Driving of a multifunction device

(76) Inventors: Isabelle Belanger-Basset, Paris (FR); Francois Kanounnikoff, Fontenay Sous Bois (FR)

Correspondence Address: MCKENNA LONG & ALDRIDGE LLP, 1900 K STREET, NW, WASHINGTON, DC, 20006, US

(21) Appl. No.: 11/806,653

(22) Filed: Jun. 1, 2007

(30) Foreign Application Priority Data
Sep. 6, 2006 (FR) 06 05147

(51) Int. Cl. G06F 3/00

(52) U.S. Cl. 719/322

(57) ABSTRACT

This method of connecting a multifunction device to a computer is characterized in that it comprises transmitting, by said device, a device identifier to said computer; executing, by said computer, a driver of the device associated with said device identifier; obtaining of a list of the functions of the device by said computer; triggering, by the driver of the device and on said computer, the execution of drivers associated with said listed functions and; managing, by said driver of the device, the data streams between the various functions of the device and said corresponding function drivers.

This application claims priority from French Application FR 06 05 147 filed Jun. 9, 2006, which is hereby incorporated by reference in its entirety.

### BACKGROUND OF THE INVENTION

The present invention relates to the drivers of multifunction electronic devices intended to be connected to computers.

Most electronic devices, such as electronic cards or peripherals, intended to be linked to a computer, require drivers executed by the computer.

These drivers are basically computer programs, suitable for driving the operation of the device when they are executed by the computer.

In general, computers comprise sizeable databases which catalogue the drivers available or links to external databases, such as databases accessible on the internet.

Each device comprises a device identifier and declares itself to the computer or, more precisely, to the operating system of the computer, when it is connected thereto. This declaration is made during a so-called enumeration phase.

The device identifier transmitted during enumeration allows the computer to find, in an internal or external database, the driver corresponding to the device.

Once the driver has been identified and then loaded into memory, it is executed on the computer, thereby making it possible to access the functions of the device.

In certain embodiments, the driver of the device instructs the transmission of a control module to the device which executes it. This control module is also called “firmware” and communicates with the driver executed by the computer. In general, the control module is stored in a temporary manner in the device in such a way as to be easily updated so as to upgrade the functionalities of the device.

Additionally, certain devices offer several functions, each requiring its own driver and having its own identifier. In certain cases, the connecting of such a multifunction device requires two enumeration phases. During a first enumeration, the device transmits its device identifier to the computer and the computer uses the identifier to load and then execute a corresponding driver, bringing about the transmission, to the device, of a control module.

The control module then simulates the disconnection of the device and embarks on a second enumeration or re-enumeration in the course of which function identifiers, which are distinct from the device identifier and distinct from one another, are transmitted to the computer. Each of these function identifiers corresponds to one of the functions of the device. In response to the receipt of these function identifiers, the computer executes drivers, each allowing the driving of a corresponding function through the control module.

Such an embodiment has some drawbacks however. Specifically, certain types of computer are designed to enter standby modes when they are not used for a certain time or under other conditions. These standby modes, or hibernation, generally entail shutting down the supply to the peripherals and devices connected to the computer. As a consequence of such shutdowns, the temporary memory of the device is erased, so that the control module, suitable for talking to the drivers corresponding to the functions, is also erased.

When the computer restarts on completion of a standby period, it is then no longer capable of driving the device which presents a device identifier that differs from those with which the drivers loaded into the memory are associated, these drivers being associated with the function identifiers obtained after re-enumeration. The effect of this is that the computer destroys these function drivers from its memory. As a result, the currently executing software package which uses these function drivers ceases to operate.

### SUMMARY OF THE INVENTION

An aim of the present invention is to make it possible to connect and use a multifunction device whose behaviour is not impaired by a temporary shutdown of the supply.

Accordingly, the subject of the present invention is a method of connecting a multifunction device to a computer, characterized in that it comprises:
transmitting, by said device, a device identifier to said computer;
executing, by said computer, a driver of the device associated with said device identifier;
obtaining a list of the functions of the device by said computer;
triggering, by the driver of the device and on said computer, the execution of drivers associated with said listed functions and;
managing, by said driver of the device, the data streams between the various functions of the device and said corresponding function drivers.

The exchanges between the device and the computer are thus always done through the driver of the device, making the whole assembly robust to the occurrence of breaks in the supply to the device and avoiding re-enumeration.

According to other characteristics of the invention:
said executing the driver of the device triggers transmitting, to the device, a control module suitable for drawing up said list of functions, thereby making it possible to upgrade the exchanges between the computer and the device;
said driver of the device is also a driver of one of the functions of the device, this embodiment making it possible to simplify the overall architecture;
one of the functions of said device is a function for receiving a television signal and another function of the device is a function for receiving an infrared signal.

The invention also relates to a computer program for driving a multifunction device intended to be connected to said computer, said program comprising software code instructions which, when executed by a processor of said computer, bring about:
in response to the receipt of a device identifier, executing, by said computer, a driver of the device associated with said device identifier;
in response to the receipt of a list of the functions of said device, triggering, by the driver of the device and on said computer, the execution of drivers associated with said listed functions and;
managing, by said driver of the device, the data streams between the various functions of the device and said corresponding function drivers.

According to other functionalities of this program:
it comprises software code instructions which, when executed by a processor of said computer, bring about on completion of the execution of the driver of the device, the transmission, to the device, of a control module suitable for drawing up said list of functions; and
it comprises software code instructions which, when executed by a processor of said computer, bring about the processing of one of the data streams originating from said device.

### BRIEF DESCRIPTION OF THE DRAWINGS

The invention will be better described in the light of the following description, given with reference to the appended drawings, in which:

FIG. 1 schematically represents a computer connected to a multifunction device; and

FIG. 2 represents the flowchart of the method of the invention.

### DESCRIPTION OF PREFERRED EMBODIMENTS

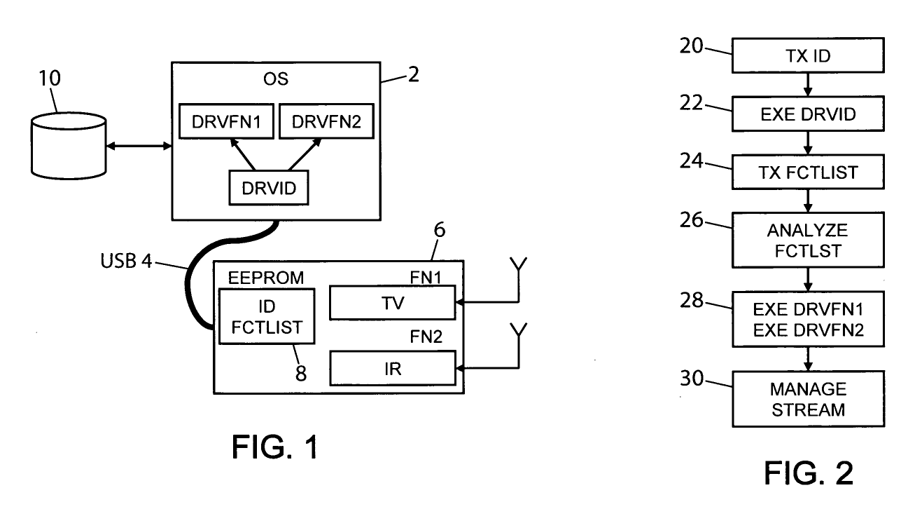

Represented in FIG. 1 is a computer, such as a personal computer 2, running an operating system or OS in a conventional manner.

This computer 2 is connected by way of a link 4 of USB type to a television reception device 6 controlled by infrared.

In the example, this device takes the form of an electronic card operating by virtue of the supply provided by the USB connection 4.

The card 6 is suitable for implementing several functions. A first function FN1 allows the reception of a television data stream and in particular, of a digital or analog television program. A second function FN2 allows the reception of an infrared data stream corresponding to the selection of a television channel transmitted by an infrared remote control.

The integration onto an electronic card of processing chains for dealing with such data flows is conventional and will not be described in further detail here.

Additionally, the card 6 also comprises a permanent memory 8 such as an EEPROM in which are stored a device identifier denoted ID and a list of the functions implemented by the card 6 denoted FCTLIST.

Finally, the computer 2 has access to a database 10 comprising drivers. This database 10 contains in particular drivers denoted DRVFN1, DRVFN2 AND DRVID, associated respectively with each of the functions FN1 and FN2 and with the device identifier ID.

The method of connecting the multifunction device according to the invention will now be described with reference to FIG. 2.

When the card 6 is connected to the computer 2 for the first time, an enumeration phase ensues between the operating system OS and the card 6. This enumeration phase comprises a transmission step 20 in which the card 6 sends the device identifier ID to the computer. This step is carried out in a conventional manner in particular by using a bus enumerator function implemented by the USB interface.

On completion of this transmission step 20, the operating system retrieves the driver of the device 6 DRVID from the database 10 and executes it during a step 22.

The execution of the driver DRVID causes the computer to obtain the list of the functions FCTLIST of the card 6, during a step 24. This is done by exchange of requests and responses between the operating system OS and the card 6.

The driver of the device DRVID comprises a particular structure suitable, when it is executed, for triggering the execution of other drivers and in particular, the execution of the drivers of the functions FN1 and FN2. Furthermore, the driver DRVID is suitable for managing the streams between various drivers and the device, as will be described in greater detail later.

The method thereafter comprises an analysis of the list of functions FCTLIST during a step 26, which culminates in the triggering, by the device driver DRVID, of the execution on the computer 2 of the drivers associated with the listed functions, that is to say the drivers DRVFN1 and DRVFN2 during a step 28.

Finally, the method of the invention comprises a step 30 of management by the device driver DRVID, of the data streams between the card 6 and the function drivers DRVFN1 and DRVFN2. Thus, the functions FN1 and FN2 communicate with their corresponding drivers DRVFN1 and DRVFN2 through the device driver DRVID.

More precisely, in the example, the data streams transmitted by the processing chains corresponding to the functions FN1 and FN2 are transmitted on the bus USB 4 using the same device identifier, that is to say the identifier ID, but additionally with an indicator or tag labelling the various functions.

The data streams transmitted on the USB connection are therefore referenced by the same identifier ID and are addressed to the corresponding driver, that is to say to the driver DRVID. As the driver DRVID is tailored for managing the data streams, it labels the indicators corresponding to the various functions so as to steer the data streams to each of the function drivers.

Subsequently, the computer 2 is placed on standby and this brings about, in the example, a shutdown of the supply on the USB connection 4.

When the computer comes out of its standby period, the driver of the device DRVID verifies the presence of the corresponding device on the USB connection. This verification is positive since the identifier ID is stored in a permanent manner in the card 6. Consequently, communications will resume directly and without interruption between the card 6 and the driver of the device DRVID. This driver DRVID then manages the streams between the various processing chains corresponding to the functions FN1 and FN2 and the corresponding drivers DRVFN1 and DRVFN2 as described previously.

Thus, the problem described initially is solved by virtue of the driver of the invention and the shutdown in the supply does not impair the operation of the card and of the computer.

Of course, other embodiments are also possible.

In a variant, the device driver DRVID coincides with the driver of one of the functions.

In another variant, the list of functions present on the card 6 may be drawn up dynamically rather than statically as in the example described.

In such an embodiment, when the card 6 is connected to the computer, the driver of the card is executed and instructs the transmission of a control module to the card. This control module, once transmitted to the card, verifies the functions available on the card and draws up the list of functions to be transmitted to the device driver DRVID in the computer. The method then continues as described previously.

Should the case arise in which there is a break and subsequent resumption in a supply, the transmission of the control module and the dynamic enumeration may be carried out again but in no case does the device present a different identifier from those with which the drivers loaded into the memory are associated.

Consequently, the function drivers are never destroyed from the memory of the computer and the software packages therefore continue to operate normally.

Specifically, when operations resume, the computer and the card are still able to talk to each other by virtue of the device driver. If the control module is necessary for communications, it is transmitted again so as to instruct the execution of the corresponding drivers, once the list of functions has been received.

If this module is not necessary, the function drivers communicate directly through the driver of the device without any enumeration being necessary.

Additionally, embodiments other than a USB-type connection may be envisaged, such as PCI-type connections, and the use of any type of analog or digital television stream.

In an embodiment using a PCI-type interface, the device is connected when the computer is off and is detected by the BIOS on startup. Subsequently, drivers managed by the operating system take charge of the exchanges with the device.

Additionally, the invention is not limited to the use of two functions on one and the same device but may of course be applied to a greater number of functions.

1. Method of connecting a multifunction device to a computer, comprising:
transmitting, by said device, a device identifier to said computer;
executing, by said computer, a driver of the device associated with said device identifier;
obtaining a list of the functions of the device by said computer;
triggering, by the driver of the device and on said computer, the execution of drivers associated with said listed functions and;
managing, by said driver of the device, the data streams between the various functions of the device and said corresponding function drivers.

2. Method according to claim 1, wherein said executing the driver of the device triggers transmitting, to the device, a control module suitable for drawing up said list of functions.

3. Method according to claim 1, wherein said driver of the device is also a driver of one of the functions of the device.

4. Method according to claim 1, wherein one of the functions of said device is a function for receiving a television signal and another function of the device is a function for receiving an infrared signal.

5. Computer program medium for driving a multifunction device intended to be connected to said computer, said program comprising software code instructions which, when executed by a processor of said computer, bring about:
in response to the receipt of a device identifier, executing, by said computer, a driver of the device associated with said device identifier;
in response to the receipt of a list of the functions of said device, triggering, by the driver of the device and on said computer, the execution of drivers associated with said listed functions and;
managing, by said driver of the device, the data streams between the various functions of the device and said corresponding function drivers.

6. Computer program medium according to claim 5, further comprising software code instructions which, when executed by a processor of said computer, bring about on completion of the execution of the driver of the device, the transmission, to the device, of a control module suitable for drawing up said list of functions.

7. Computer program according to claim 5, further comprising software code instructions which, when executed by a processor of said computer, bring about the processing of one of the data streams originating from said device.
